(19) United States
(12) Patent Application Publication
(10) Pub. No.: US 2025/0073007 A1
(43) Pub. Date: Mar. 6, 2025

(54) METHOD AND DEVICE FOR CLEANING IN THE ORAL CAVITY

(71) Applicant: epitome GmbH, Wien (AT)

(72) Inventors: Wilhelm ZACKL, Wien (AT); Andreas RAMBERGER, Wien (AT); Lukas RÖSCH, Wien (AT); Bernhard WEISS-BOUSLAMA, St. Andrä-Wördern (AT)

(21) Appl. No.: 18/258,313

(22) PCT Filed: Dec. 17, 2021
(86) PCT No.: PCT/EP2021/086522

§ 371 Date: Jun. 19, 2023

(30) Foreign Application Priority Data
Dec. 18, 2020 (DE) 10 2020 134 154.7

(51) Int. Cl. A61C 17/028; A61C 17/02

(52) U.S. Cl. CPC A61C 17/028; A61C 17/0208

(57) ABSTRACT

A method for cleaning surfaces, in particular teeth, interdental spaces, and gums, wherein a liquid volume is produced around a surface to be cleaned and a pulsed liquid flow is directed onto the surface to be cleaned with at least one assembly comprising at least one nozzle.

### TECHNICAL FIELD

The invention relates to a method and device for cleaning surfaces in the oral cavity, in particular a method for cleaning teeth, interdental spaces, and gums in the oral cavity.

### DESCRIPTION OF RELATED ART

In the field of tooth cleaning, improvements in cleaning are continuously being sought. Conventional cleaning with a toothbrush and toothpaste has a number of disadvantages.

Conventional toothpastes have up to 20% abrasive components; the abrasive components together with excessive pressure on the brush by the user can lead to massive erosion of tooth material over time. With the increasing average life expectancy, this has led to the fact by the time old age is reached, teeth have been veritably brushed to death and this leads to problems.

In addition, the toothbrush has the disadvantage that it can damage the gums, particularly when brushing is not performed properly so that periodontal disease is a common problem. Most of the biofilm that forms the contamination is located directly above or below the gums, which is why cleaning at or next to the gums is very important. This is particularly difficult for toothbrushes because the brush comes into contact with the gums and irritates them.

In addition, brushing with a toothbrush and toothpaste is not sufficient from an oral hygiene standpoint because in particular, the interdental spaces (up to 40% of the surface to be cleaned) and the gingival pockets are not cleaned sufficiently because the toothbrush does not reach these regions.

Plaque (=oral biofilm), which is formed by bacterial processes and from which tartar forms in later stages, is a film of contamination that adheres to surfaces and to itself comparatively well and cannot be easily removed, even when it is cleaned by direct contact with the toothbrush, but certainly not in the interdental spaces, into which the toothbrush can only penetrate to a limited degree or not at all.

Conventional cleaning with a toothbrush therefore requires additional cleaning measures such as the use of dental floss or interdental brushes to clean in the interdental spaces, particularly the regions where the teeth about each other, but also the interdental spaces. Even when using dental floss, however, there is a certain possibility of misuse, because in particular the gums can also be injured with dental floss, particularly in the region of the interdental pockets, where the bacterial load is particularly high. This can lead to gingivitis, among other things.

In the past, there have been a variety of attempts to develop other approaches to cleaning. For example, it is also known to clean the interdental spaces with water jet devices. It has turned out that although the water jet devices of earlier times were in fact able to produce a cleaning effect, the hardness of the jet could easily damage the gums. Modern devices have been significantly reduced in terms of the jet power so that they no longer cause immediate damage to the gums, but this has also reduced the cleaning performance so much that these devices are largely ineffective.

In addition, many attempts have been made to provide so-called ultrasonic brushes, in which a vibration of the toothbrush, which is used for cleaning and ultimately, together with toothpaste, in turn produces an abrasive cleaning, is combined with ultrasonic vibrations, which are supposed to produce a cleaning effect. It has turned out, though, that such toothbrushes are not able to couple the ultrasound into the oral cavity in such a way that it would even be possible to verify the production of any such cleaning effect. Such so-called ultrasonic toothbrushes are therefore not significantly better than a conventional manual toothbrush.

Other electric toothbrushes in which the brush head makes circular or vibrating movements do often have pressure control, but ultimately these movements also result in an abrasive brushing.

DE 20 2016 101 191 U1 discloses a brush head for an electric toothbrush, which is intended to surround the tooth on all sides and on which bristles are positioned for cleaning.

U.S. Pat. No. 3,401,690 A discloses a cleaning device in which ultrasound is applied to a surface via a liquid through a clamp, which embraces at least one tooth.

US 2005/091770 A discloses a toothbrush that works like a normal electric toothbrush, but also has an ultrasonic generator, which is to introduce acoustic energy into a cleaning liquid.

US 2017/0189149 A1 discloses a system for whitening teeth with an ultrasonic device. A mouthpiece is provided for this purpose, which has a volume for the upper jaw and a volume for the lower jaw; ultrasonic generators are positioned in the mouthpiece facing the teeth and can apply ultrasonic energy to the tooth surface.

This is intended to produce an effect known as ultrasound streaming; it is stated that the temperature must be controlled and also bubbles must be prevented from forming since they hinder the transmission of the ultrasound. A frequency of 20 kHz to 100 KHz is to be used in this case; the purpose of this is to deliberately induce a cavitation so that vapor bubbles form which implode on the surface of the tooth, the purpose of which is to generate local temperatures of up to 5000 Kelvin and local pressures of up to 1000 atmospheres.

The disadvantage here is that the amounts of energy introduced are so high that damage to the tissue is practically inevitable.

WO2007/060644 A2 discloses a method and device for removing biofilm by means of so-called “microstreaming.” In this case, the intent is to cause gas bubbles to resonate by means of ultrasound, which is supposed to result in a cleaning effect. The purpose of the ultrasonic excitation is to cause the gas bubbles to vibrate, which induces an acoustic streaming in a small region in the vicinity of the bubble. This acoustic streaming is also known as microstreaming. This microstreaming is supposed to generate shear a force capable of removing the biofilm. The corresponding gas bubbles can be prefabricated and in particular, these bubbles can also be generated in a phospholipid or protein environment to stabilize them.

WO2009/077291 A1 also discloses a method for introducing antimicrobial reagents into a biofilm; in this case, gas bubbles are introduced into a treatment chamber in a plastic envelope, the plastic envelope is then destroyed by ultrasound and the bubbles are thus released. The gas bubbles, in turn, are excited by the ultrasound frequency so that they vibrate and after reaching a maximum amplitude of vibration, collapse, thus rupturing the biofilm.

WO2010/076705 A1 discloses a toothbrush that, in addition to bristles, contains an ultrasonic generator that introduces ultrasound into a treatment chamber, with microbubbles also being introduced. This can, but does not have to, produce cavitation.

WO2020/212214 A1 discloses a method in which a toothbrush is to be coupled to a water jet device, the water jet device being controlled in such a way that when the toothbrush is guided past the interdental spaces, a water jet rinses the interdental spaces. Suitable acceleration, velocity, or displacement sensors are to be used for this purpose.

WO 2020/212248 A1 discloses a method in which a water jet device is also coupled to a toothbrush; a controller is provided, which uses predetermined data and user-specific data to estimate the location of the cleaning device in the mouth, said data including, among other things, data relating to the cleaning activity of the user or the operation of the cleaning device and being used to estimate the location in order, when an interdental space is reached, to rinse it with the water jet.

A disadvantage of the known methods is that experiments have shown that cleaning with (imploding) bubbles alone is not sufficient. Either the cleaning performance is too low or the cleaning performance is higher, but at a higher cleaning performance that is not necessarily sufficient, an energy range is reached that is not safe, since in these energy ranges, cavitation can occur that can in certain spots result in destruction of both the gums and the tooth material. In order to preclude the occurrence of such destruction, this range must be avoided by a rather large margin, which results in ineffective cleaning performance. Ultimately, combining microbubbles with conventional toothbrushes only combines the disadvantages of the two technologies.

DE 42 08 664 A1 discloses a nozzle head assembly for water flossing equipped with a nozzle head forming a tunnel; the nozzle head is embodied with multiple spray nozzles on the inside, which are successively acted upon by pressurized liquid of a pressure pump through control valves.

US 2012/0003601 A1 discloses a tooth cleaning device with a device for generating a spray jet, which pressurizes a liquid by means of a piezo element and can direct it at a tooth to be cleaned, and also discloses a detection device for detecting a marker of oral health. The device in this case is very bulky and hardly suitable for end-user use.

US 2019/0110875 A1 discloses a method for cleaning teeth in which a liquid is to be ejected and aspirated in reciprocating fashion, with the liquid being ejected on one side of a row of teeth and being aspirated on the other side in reciprocating fashion, this being controlled by valves which open the one or the other transport path in reciprocating fashion. The disadvantage of this method is that it does not work since the rapid alternation desired fails due to the inertia of the liquid on the one hand and the frictional resistance in the lines on the other.

US 2019/0236236 A1 discloses a mechanically driven oral care appliance in which pulsed jets of liquid are generated and guided over the teeth in the conventional manner by means of a manually guided nozzle. As with manually guided toothbrushes, the disadvantage here is that a large number of user errors are possible, which among other things, can lead to massive damage to the gums.

The object of the invention is to create a method for cleaning surfaces, and in particular tooth and gum surfaces and interdental spaces, which removes biofilm from gums, interdental spaces, and teeth simply, quickly, and safely, and also effectively and in a non-hazardous manner, and which is also comfortable to use.

Another object is to create a device that effectively cleans tooth and gum surfaces and interdental spaces, which removes biofilm from gums, interdental spaces, and teeth simply, quickly, and safely and also effectively and in a non-hazardous manner and is also comfortable to use.

### SUMMARY OF THE INVENTION

According to the invention, a pressure jet or pressure pulse of a predetermined strength and velocity is sent through at least one nozzle at a surface to be cleaned, wherein due to the nature of the liquid or liquid medium, the pressure surge, which introduces a small volume of liquid into the liquid volume, propagates through the liquid to a surface to be cleaned.

In one advantageous modification, fluid mechanical effects are used in this connection. In particular, flows and vortices that are annular in the broadest sense are used in this case. The effects that can be produced by such flows and vortices are described below. By means of appropriate nozzle geometries on the one hand and compliance with certain boundary conditions with regard to the quantity and velocity of an ejected medium on the other, toroidal closed vortex filaments, hereinafter referred to simply as torus or in the plural as tori, can be generated.

In the simplest case, such a flow or vortex results in a flow transverse to a surface to be cleaned after the torus has passed through the surrounding medium to the surface to be cleaned. Such a flow may in itself already be capable of causing biofilm or plaque to detach.

If there are solid particles within the ejected liquid and/or in the surrounding medium, these are entrained with the vortex or torus and are correspondingly also moved across the surface to be cleaned, which naturally intensifies the cleaning effect. In this case, such solid particles can be entrained in a simple manner or carried along by the torus so that a particle is also guided across a surface several times. In so doing, the particle or particles rotate with or in the torus or rotate around the torus. Thus, a particle can sweep across the surface several times and remove biofilm by means of the shear forces. This is different from a jet in which a particle is guided across the surface only once.

Depending on the relative velocity through the surrounding medium or the rotation speed of the torus, cold vapor can also be generated within the torus. In this case, in addition to the above-described effects, the torus or more precisely the cold vapor bubbles will collapse at the surface, causing an additional flow effect due to transverse flows.

But toroidal closed vortex filaments also exist without cold vapor. Particles are also moved by their flow resistance along the surface to be cleaned. The flow resistance of the particles increases with their size and as a result, the shear forces acting on the biofilm also increase when a particle is moved along its surface.

In principle, the nozzles in this case can be circular in cross-section, but they can also have any other shape, for example elliptical or narrow slit-shaped, star-shaped, or generally irregular. Accordingly, the closed vortex filaments are not necessarily circular and thus do not constitute tori by definition.

For these nozzle geometries, the hydraulic diameter can be used as a substitute diameter Dh=4*A/P, where A=cross-sectional area and P=wetted circumference.

The circular torus is advantageous because it is particularly stable and propagates far into the liquid without any noticeable change in shape.

However, the stability of the closed vortex filaments of other geometries may well be sufficient for the required cleaning distance and permit an adaptation to the tooth geometry.

It has been discovered that at a ratio of the length of the ejected liquid cylinder to its diameter of up to a maximum of 4, these tori form.

At a ratio above this, up to about 10, a mixed range exists whose boundaries are not sharp.

Exactly how far the mixed range extends and where a pure jet exists is fluid and therefore cannot be determined precisely.

Information about this can be found in D. G. Akhmetov “Vortex Rings” ISBN 978-3-642-05015-2, in particular FIGS. 3.6 and 3.7.

FIG. 3.7 shows the relationships quite clearly, where Up*t is the so-called slug length, i.e. the cylinder length of the ejected fluid. Up=velocity of the fluid, t=ejection time, and D=nozzle diameter.

At Up*t/D=2 a clear torus is observed, at 3.8 (approx. 4) it is still a torus, while at 8 there is already a mixture of a torus and a jet, i.e. a mixed form which also contains secondary smaller vortices.

FIG. 3.6 from the same book shows that starting from Up*t/D=3.8, the circulation no longer goes into the torus for all practical purposes.

Among other things, toroidal rings also have the advantage that they can bridge a large distance range between the nozzle and the surface to be cleaned.

In addition, torus rings can even bridge much greater distances than are necessary for the purpose specified here. In the free liquid, tori with cold vapor cover up to about 30 to 50 mm with nozzle diameters of around 1.5 mm. This means that when tori are used, a surface to be cleaned is reliably reached in every case.

According to the invention, the cleaning liquid can be sucked back and reused in the process, wherein the back-suction takes place via the ejection opening of the nozzle, via back-suction openings positioned adjacent to the nozzle or central back-suction openings and the liquid is fed back into the process. The inventors have discovered that without a back-suction, too much liquid can enter the oral cavity and this can be uncomfortable for the user; the inventors have also discovered that the method can be carried out more efficiently if the liquid is reused in the same process.

The nozzles of the same shuttle can also be operated in a chronologically staggered fashion to reduce the leakage losses of the sealing lips and to keep the liquid content as constant as possible.

According to the invention, a surface to be cleaned or a partial region thereof can be surrounded with a closed liquid volume and one or more nozzles can be positioned within this closed liquid volume. The back-suction can take place inside and/or outside the closed volume. The back-suction can therefore take place inside the created closed volume and/or outside it, i.e. in the oral cavity. In the oral cavity, liquid that is present due to inevitable leaks can be sucked back.

In addition, the back-suction in the oral cavity can also take place at the end of a treatment. In particular, with a back-suction from the oral cavity at the end of the treatment, saliva and cleaning liquid can also be suctioned off to enable the cleaning device to be used safely and without soiling clothing and without allowing liquid to run out of the mouth.

According to the invention, a cleaning fluid, and in particular a cleaning fluid with particles, is periodically sucked in and ejected, with the fluid paths being in the vicinity of the teeth, i.e. particularly at a distance of <3 cm from the nozzle to the tooth surface.

The aim is to generate a periodic pulsed jet through one or more nozzles, which is directed at the surface to be cleaned and can be directed at the tooth orthogonally to tangentially simply due to the shape of the teeth, particularly in the region of the interdental spaces, but also due to a change in the ejection angle.

This cleans the tooth surface but also the gums, and also cleans the interdental spaces and the gingival pockets. The periodicity in this case refers to the period of the process of the continuously repeated suction and ejection. This expressly does not mean that this occurs with a constant time interval. A suction and ejection at regular intervals is encompassed by the invention in the same way as a suction and ejection at stochastic time intervals.

In one modification, a closed treatment chamber is provided according to the invention, wherein a cushion-like element or sealing element produces a cleaning fluid volume in front of the nozzle, in particular by means of elastic sealing lips that are positioned around the nozzles or a nozzle assembly and also rest against the teeth in an elastically sealing fashion. In particular, the sealing cushion can adapt to the surfaces. In this connection, “sealing” or “creating a liquid volume” does not mean that this volume is absolutely liquid-tight; leakage of liquid is inevitable to a certain extent and can easily be accepted.

It can also be advantageous if a certain amount of leakage of liquid but not of particles occurs because particles can thus concentrate in the cleaning fluid volume, which in turn results in more cleaning particles per pulse and per nozzle and thus in better cleaning performance. The concentration in this case can occur by means of the sealing lips if they hold back the particles more powerfully than the fluid. The particles then only have to be supplied at a lower concentration with the fresh cleaning fluid, which in turn advantageously impedes or prevents a clogging of the supply lines.

Accordingly, due to its elasticity, the cushion can catch at least most of the volume flowing in through the nozzle; incidentally, complete tightness is also not out of the question. Ideally, therefore, the closed volume between the nozzle and the surface to be cleaned does not lose any cleaning liquid and, ideally, the cleaning liquid can thus be reused an infinite number of times by being sucked in and ejected, for the respective jet to be cleaned. But since in reality, losses of cleaning fluid appear to be inevitable, for example due to interdental spaces or leaks at the sealing lips due to the surface shape of the surface to be cleaned, which must be compensated for by an inflow of cleaning liquid, the total inflow is greater than the volume.

The inflow in this case can take place through the respective nozzle itself or through the respective nozzle assembly itself so that an average flow of fluid flows through the nozzle or nozzles. But the closed volume can also be replenished with a sufficient amount of cleaning liquid from elsewhere, in which case the fluid flow through the nozzle averaged over a period of time is zero.

According to the invention, the ejection of the jet can take place via the nozzle and the suction can likewise take place via the nozzle, via other nozzles or valves, or only via valves and intake openings.

As explained above, the nozzle shape can deviate from a circular cross-section and can have any other shape. In longitudinal section, the nozzle can be embodied as cylindrical or without divergence or convergence of the boundary walls, but can also be embodied as conical.

FIG. 29 from D. G. Akhmetov “Vortex Rings” ISBN 978-3-642-05015-2, for example, shows a torus generator which has a conical nozzle. This can result in a better efficiency in the detaching procedure.

For the pulsing required to generate the torus and/or jet, the driving frequencies of the pulsation are between 1 Hz and 50 kHz, in particular between 1 Hz and 30 kHz, and especially from 1 Hz to 1 KHz.

Particularly when producing a jet, the pulsation frequency is preferably between 1 Hz and 1 kHz, in particular between 30 Hz and 300 Hz, and preferably >50 Hz.

Particularly when generating the torus, the pulsation frequency is preferably between 1 Hz and 20 kHz, preferably from 50 Hz to 1 kHz, and more preferably from 50 Hz to 300 Hz.

Pulsation frequencies of >50 Hz are quite reasonable, because in this way a short cleaning time can be achieved with a comfortable shuttle size (number of nozzles).

For example, pulse lengths range from 0.03 milliseconds to 1 second.

Particularly when generating a jet, the pulse lengths are 0.3 ms-1 sec, preferably 0.3 ms-500 ms, more preferably 0.3 to 100 ms, even more preferably 0.3 to 20 ms, and in particular 0.3 ms-5 ms.

Particularly when generating a torus, the pulse lengths can be shorter and in particular, 0.03 ms-3 ms, particularly 0.07 ms to 0.7 ms, preferably 0.1 ms to 0.4 ms. The also depends on the size of the torus.

When using particles, particles from 1 μm to 0.5 mm can be used.

The overall flow velocity out of the nozzle can range from 15-100 m/s, with jets using velocities of 15-40 m/s since damage is certain to be produced above this and no cleaning is achieved below it.

When generating tori, the velocity in the nozzle can be higher and the maximum pressures in the nozzle chamber can also be much higher for a short time, particularly with very short pulses, because then the kinetic energy is transmitted to the cold vapor bubble and as a result, the effective velocity of the fluid is much lower in the torus and thus at the tooth.

The desired particle density in the closed volume is preferably less than 30 percent by volume, in particular less than 20 percent by volume, and especially less than 15 percent by volume relative to the liquid contained in the closed volume.

The desired particle density in the initial cleaning liquid that is conveyed in the device is preferably less than 10 percent by volume, in particular less than 5 percent by volume, in each case relative to the volume of the cleaning liquid.

The closed volume according to the invention, which can be closed off by means of corresponding sealing lips or other sealing elements, has turned out to be helpful to the inventors since for many people, it is uncomfortable when the mouth is filled with cleaning fluid and in particular, the fluid volume continues to increase and, when the device is removed, cleaning fluid that is still present runs out of the mouth or soils clothing.

According to the invention, the cleaning fluid is correspondingly kept within the closed volume; after the end of the cleaning process, the cleaning liquid contained in the closed volume can also be completely sucked out by means of the above-described back-suction according to the invention.

In this case, the closed volume can be produced around one or more teeth, closed around a jaw branch or for example around differently shaped teeth depending on the tooth shape, for example so that one volume is produced around molars, one volume is produced in the canine region, and one volume is produced in the incisor region.

A total volume for an entire jaw can also be produced with corresponding nozzle assemblies, but partitions or dividers, in particular elastic partitions or dividers, for example, are provided between the differently shaped regions delimiting the volume, which also support the nozzles.

The design is thus flexible, but all of the possible options share the fact that the closed volume holds the fluid around the surface and significantly reduces the amount of fluid in the mouth.

As explained above, there are also multiple variants according to the invention when it comes to the liquid guidance.

In a first variant, a jet is ejected from a nozzle opening and, after the jet has been ejected, liquid is sucked back in via the nozzle in order to keep the volume within the closed volume or the amount of liquid within the closed volume as constant as possible. Since the jet is ejected as a pressure surge, the back-suction will logically take a longer time than the ejection.

In another variant, a nozzle opening is provided through which the liquid jet is ejected; to fill the closed volume, the cleaning fluid is first introduced via a separate inflow opening, but in this case, too, the production of the pressure surge and the back-suction of the liquid take place via the nozzle.

In another embodiment according to the invention, the liquid is ejected via the nozzle opening, but a back-suction opening is provided adjacent to the nozzle opening so that when a negative pressure is applied to the region of the nozzle, the liquid is sucked back both through the nozzle and through the adjacent back-suction opening. For this purpose, the back-suction opening preferably has a simple valve, for example a diaphragm valve, which closes the back-suction opening when the liquid is ejected and opens it when a negative pressure is applied for the purpose of back-suction. Instead of one back-suction opening, of course multiple back-suction openings can also be provided; these can, for example, be positioned in an annular arrangement or the like around the ejection nozzle.

In another variant, the latter variant is combined with the variant mentioned second so that in these cases, one or more inflow openings for filling the volume, at least one nozzle for producing the pressure surge, and at least one back-suction opening are provided.

In addition, the aforementioned variants can also be combined with a closing device for the nozzle, which closes the nozzle either when liquid is flowing in or when liquid is being sucked back in. Basically, according to the invention, it is desirable of the back-suction to take place as quickly as possible and preferably, does not take much longer than the ejection since otherwise, the cleaning procedure takes too much time. In particular, the use of a valve and also the use of a suitable back-suction opening of suitable size or multiple back-suction openings enable a rapid suction.

The basic cleaning is performed by the jets. According to the fluid dynamics, when jets are produced, a zone at a pressure lower than the pressure surge—even as low as a negative pressure—can optionally be produced behind the pressure surge so that the surface to be cleaned is subjected to a pressure change. It has turned out that this approach not only effectively damages the biofilm, but also effectively detaches it since the shear forces generated by the pressure change are so strong that the biofilm does not continue to adhere and does not close up again and instead, is transferred into the cleaning liquid.

The pressure surge in this case can be so strong that a transition to the vapor phase occurs on the negative pressure side so that cold vapor bubbles are produced. These bubbles collapse due to the pressure equalization when they reach the tooth surface and their volume is correspondingly filled again with liquid. The microstreaming effect resulting from this is not absolutely necessary for the cleaning, but if it occurs, can certainly promote the latter.

It has also surprisingly turned out that a small amount of organic or mineral adjuvants or additives improves the cleaning effect even more; these mineral additives do not have an abrasive effect of the kind that takes place with a toothbrush and mechanical friction movements, but contribute to it through their kinetic energy. In this case, as already stated above, the proportion is less than 10% by volume in the initial cleaning liquid and is less than 30% by volume in the closed volume.

The method can include ejecting the liquid or generating the pressure pulses from multiple nozzles which are combined in a nozzle shuttle; such a nozzle shuttle encompasses one or more teeth on all sides, i.e. is approximately inverted U-shaped (molars) or double I-shaped (incisors) and this shuttle is guided over the teeth, for example from the wisdom teeth in the direction of the incisors; multiple shuttles can also be provided so that the incisors are cleaned by one shuttle and the molars are cleaned by another shuttle.

The advantage of the invention is that simple, safe, and gentle cleaning of the teeth, interdental spaces and gum region is achieved, which ensures an effective cleaning that is less abrasive and possibly even non-abrasive.

The invention thus relates in particular to a method for cleaning surfaces, in particular teeth, interdental spaces, and gums, in which a pulsed liquid flow is directed at the surface to be cleaned using at least one assembly comprising at least one nozzle and in which at least a portion of the liquid is sucked back in and recirculated.

The advantage of this is that a pressure pulse, which is generated in a liquid volume by a nozzle and which injects a defined quantity of a liquid into the liquid volume, generates a pressure surge moving through the liquid volume, which generates shear stresses at a surface to be cleaned. It is also advantageous that the total amount of liquid present in the oral cavity can be limited and in addition, the liquid can be reused so that it is possible to limit the amount of cleaning liquid used.

In one modification, the amount of liquid sucked back in essentially corresponds to the amount of liquid supplied via the at least one nozzle.

The advantage of this is that to an even better degree, it ensures that the amount of liquid does not become too great.

In one modification, a surface to be cleaned or a partial region thereof is surrounded by a closed liquid volume and one or more nozzles are positioned within this closed liquid volume.

The advantage of this is that the production of a closed volume or an enclosed space in the region of a surface to be cleaned or a partial region thereof creates a better and quasi-closed liquid circuit. This can also result in directed flows that improve the cleaning result on the one hand and the condition of the cleaning liquid with respect to gas bubbles on the other.

In one modification, the back-suction takes place inside and/or outside the enclosed space so that the back-suction takes place inside the enclosed space and/or outside, i.e. in the oral cavity.

In the case of a back-suction outside the enclosed space or closed volume, it is advantageous that the back-suction can take place at least partially centrally and then also includes saliva and cleaning liquid that has escaped from inevitable leaks so that the oral cavity can also be sucked empty, particularly at the end of the cleaning procedure and/or can be kept at a constant volume that is perceived as comfortable during cleaning by slow continuous back-suction.

With the back-suction inside the enclosed space, the cleaning liquid is advantageously recovered and reused.

The combination of both back-suction procedures, i.e. inside the closed volume and outside it, unites these advantages.

In one modification, the amount of liquid sucked back in corresponds to at most +/−20% by volume of the amount of liquid introduced into the enclosed space through one or more nozzles.

The advantage of this is that the liquid flow can be controlled particularly well, possibly by taking into account the leakage of the seal of the enclosed space.

In one modification, a jet is produced in the liquid volume with a region of high pressure and behind it, a region of lower pressure compared to the ambient pressure of the liquid in the volume.

The advantage of this is that the resulting pressure change clearly produces flow changes which in turn can produce shear stresses.

In one modification, the pressure pulse is selected to be so strong that the region of the lower pressure produces and entrains cold vapor bubbles.

The advantage of this is that the cold vapor bubbles produced by negative pressure collapse at the surface to be cleaned due to pressure equalization with the surrounding liquid. This generates additional shear forces through microflows of the liquid into the bubble volume, which can intensify the cleaning effect.

In one modification, a ratio of the jet length of the cylindrical fluid jet to the jet diameter of up to 10 and in particular below 6 and especially below 4 is set so that toroidal rings are produced.

The advantage of this is that toroidal rings can be used in a particularly favorable way to bridge different distances from the nozzle to the surface to be cleaned. By contrast with cavitation, toroidal rings also have the advantage that while they have a good cleaning effect, particularly due to microstreaming as a result of the inherent flow and the inflow in the event of a collapse, they are also capable of entraining or carrying particles along with them and thus achieving a cleaning by means of shear forces. In the event of collapse of the cold vapor bubble or bubbles, the torus rings release an energy that has nothing close to a damaging effect.

In one modification, an assembly with multiple nozzles is used.

The advantage of this is that a larger region can be cleaned per unit time.

In one modification, when surfaces are not flat or as a function of a distance from the surface, the nozzles are operated so as to control the pulse strength and/or the amount of liquid ejected from the nozzle, wherein when the distance is greater, the pulse strength and/or the pulse duration and/or the pulse frequency and/or the flow rate is/are increased.

The advantage of this is that for example in the regions of the interdental spaces close to the gums, more energy or a greater amount of flowing liquid is used for cleaning so that the cleaning effect is adapted to the expected amount of contamination on the one hand or the distance from the nozzle on the other. At the same time, regions that are not spaced as far apart, such as the tooth flanks, are subjected to lower energy.

In one modification, the at least one nozzle is oscillated around a home position in the X direction (tooth vertical axis) and/or Y direction (tooth transverse axis) and/or Z direction (toward the tooth).

The advantage of this is that oscillation around the X and/or Y direction on the one hand increases the coverage by a nozzle and on the other hand, this can prevent an introduction of energy that is too concentrated in certain points; in addition, this can produce additional flow effects and thus shear stresses, as can an oscillation in the Z direction.

In one modification, the at least one nozzle is guided along the teeth and/or gums.

The advantage of this is that all of the surfaces to be cleaned can be treated one after the other with the at least one nozzle.

In one modification, multiple nozzles are combined to form a nozzle assembly (shuttle), wherein the nozzles are arranged so that they are positioned at least over the height of one tooth and the adjacent gums, wherein the nozzle jet impingement surfaces of the individual nozzles overlap or, in the case of oscillating nozzle assemblies, the nozzle jet impingement of the nozzle overlap.

The advantage of this is that the entire region to be cleaned is cleaned by at least one cleaning line across the height from the gingival to the occlusal region, with a gap-free cleaning being ensured by the overlap.

In one modification, a different nozzle density per unit area of the assembly is used across the height of a tooth from the gingival to the occlusal region, with a higher number of nozzles being used in the regions in which the assembly is spaced farther away from the surface to be cleaned, such as the gingival pockets and the interdental spaces in the gingival region, in particular the papillae.

The advantage of this is that the regions that are more difficult to reach are located lower down or typically have a higher contamination load are subjected to a more intensive cleaning.

In one modification, multiple nozzles are combined in a respective shuttle device, wherein the shuttle device encompasses at least the region of one tooth and the adjacent gums in an inverted U-shape.

The advantage of this is that multiple nozzles are moved together and are jointly supplied with the liquid to be pulsed. In addition, this makes it easy to clean the gingival regions as well as the inner and outer tooth flanks, the interdental spaces from the inside and outside, and the chewing surface.

In one modification, the shuttle device is moved over the teeth with a moving device.

The advantage of this is that once one region has been cleaned, the neighboring region is cleaned. This makes it possible to limit the number of nozzles and supply lines. For example, two shuttle devices can be used per jaw.

In one modification, 10 to 100 nozzles or outlet openings are used per shuttle device.

The advantage of this is that with such a number, a sufficient cleaning performance is achieved and the overall dimensions do not become too large.

In one modification, a kinetic input pulse energy of up to 16 mJ for large tori and in particular, 10 mJ for jets, is used per nozzle.

The advantage of this is that the energy of the pulse in the oral cavity does not become too high and have the capacity to damage tissue or dental, with the output energy depending on the shape of the nozzle, friction losses, etc.

In one modification, the total pulse energy per mouthpiece for multiple shuttle devices or nozzle assemblies and nozzles is 200 to 800 mJ, in particular 300 to 600 mJ, when generating tori, and 200 to 500 mJ, in particular 200 to 300 mJ, when generating jets.

The advantage of this is that the total energy is low so that on the one hand, no tissue damage can occur. In addition, the equipment required outside and inside the oral cavity is minimized, thus enabling a miniaturized embodiment.

In one modification, the energy per unit time is between 12,000 and 100,000 mJ/s.

The advantage of this is that, in addition to the above-mentioned advantages, the total energy is low enough that excessive heating of the liquid in the oral cavity during the treatment period does not occur.

In one modification, pulsing is produced at a pulse frequency of between 50 and 200 Hz.

The advantage of these frequencies is that they ensure a high density of action and thus a good cleaning.

In one modification, the distance of the nozzle from a surface to be cleaned is set so that it is up to 10 mm when using jets and up to 20 mm when using tori.

The advantage of this is that a good cleaning effect is achieved in this region without stressing the tissue.

In one modification, the impact angle of the jet and/or torus on the surface of the tooth is set to range from perpendicular to tangential.

The advantage of this is that a good cleaning effect is achieved because contamination typically increases away from the chewing surface.

In one modification, the inlet pressure of the jet liquid is set to 0.1 to 2 MPa, preferably 0.12 to 0.5 MPa, upstream of the nozzle when producing jets and the inlet pressure of the liquid is set to 0.1 to 4 MPa upstream of the nozzle when producing tori.

The advantage of this is that the nozzles are sufficiently supplied with cleaning liquid, backflow effects at the nozzle are minimized, and the pulsing can be carried out without too much force.

In one modification, the cleaning liquid contains 0.1-5% by volume of particles.

The advantage of this is that such a small quantity of particles can result in significantly improved cleaning performance. The quantity is nevertheless so small that there is no abrasive effect on tissue or tooth material.

In one modification, mineral particles are used as the particles.

The advantage of this is that mineral particles have a sufficiently high hardness, are well-proven, and do not pollute the environment.

In one modification, particles with a particle size of 20-120 μm are used when producing tori with a diameter of up to 0.5 mm, in particular below 0.3 mm.

The advantage of this is that this size is sufficient for the cleaning effect on the one hand and for sufficient kinetic energy on the other. In addition, such a size is not annoying to the user.

In one modification, in order to keep the amount of liquid in the volume constant, a part of the liquid is sucked out of the volume that essentially corresponds to the amount of liquid supplied via the at least one nozzle.

The advantage of this is that less liquid overall is introduced into the oral cavity during the cleaning process, making the cleaning process more comfortable for the user.

Another aspect of the invention relates to a device for carrying out the aforementioned method wherein at least one nozzle or at least one assembly with multiple nozzles is provided, wherein the at least one nozzle is embodied to eject a jet of liquid and wherein at least one back-suction device is provided that is embodied to suck back in at least a part of the liquid ejected by the at least one nozzle.

In one modification, at least one nozzle housing is provided with at least one sealing element that is embodied to rest against a surface to be cleaned so that a cushion-like enclosed space is formed in front of the nozzle.

In one modification, the at least one sealing element is formed by one or more elastic sealing lips that are positioned around the nozzles or the nozzle housing(s) and are also embodied to rest in an elastically sealing fashion against the surface to be cleaned.

In one modification, the sealing element or elements are positioned on an outer outlet-side surface of the nozzle base body facing the surface to be cleaned, wherein the sealing elements are embodied in multiple parts or as a single circumferential sealing element and in particular are embodied as rubber-elastic.

In one modification, multiple nozzles are combined to form a nozzle assembly in a nozzle housing, wherein the nozzles are positioned so that they extend at least across the height of one tooth and the adjacent gums.

In one modification, the nozzle jet impingement surfaces of the individual nozzles overlap or, in the case of oscillating nozzle assemblies, the nozzle jet impingement surfaces of the nozzle assemblies overlap.

In one modification, multiple nozzles are combined in a respective nozzle assembly, wherein the nozzle assembly encompasses at least the region of one tooth and the adjacent gums in an inverted U-shape.

In one modification, the sealing elements or sealing lips are embodied as hollow in order to be inflated with the cleaning liquid or other fluids.

In one modification, the nozzle housing has multiple nozzle openings positioned above one another in the (jaw) sides or facing the tooth flanks and multiple nozzle openings positioned next to one another at the bottom, facing a tooth crown.

In one modification, the lateral nozzle housings are hinged to a nozzle base housing by means of elastic or articulated connections, in particular rubber-elastic connections, particularly so as to allow them to be adapted to the teeth.

In one modification, nozzle housings for one or several or all of the nozzles are each provided with an inlet for cleaning liquid.

In one modification, the nozzle housing is embodied so that an inflow conduit is provided, into which the nozzle opening opens at its rear end, wherein a back-suction opening is provided adjacent to the nozzle opening, by means of which liquid can be sucked back into the inflow conduit from the enclosed space.

In one modification, a valve is provided that closes the back-suction opening when liquid is flowing in and particularly when liquid is being ejected from the nozzle opening so that the cleaning liquid is ejected only from the nozzle opening in a controlled manner.

In one modification, the sealing lips are embodied so that particles cannot get out of the enclosed space but cleaning liquid can so that an escape of liquid but not of particles takes place to a certain extent so that particles become concentrated in the cleaning fluid volume.

### BRIEF DESCRIPTION OF THE DRAWINGS

The invention will be explained by way of example with the aid of drawings. In the drawings:

FIG. 1: is a very schematic depiction of a nozzle, showing a section through the nozzle outlet opening and the liquid space above it;

FIG. 2: is a depiction of the isobars in the space, showing the pressure distribution with a positive pressure and a negative pressure region;

FIG. 3: shows the basic design of a nozzle;

FIG. 4: shows a nozzle with a pressure surge and the cold vapor that this produces;

FIG. 5: shows several cleaning images showing the cleaning effect after 2,4, and 8 seconds;

FIG. 6: is a graph showing the cleaning performance with different cleaning particle contents;

FIG. 7: is an overview showing the cleaning performance after 1 and 2 seconds with a spot jet;

FIG. 8: shows the cleaning performance in the interdental region.

FIG. 9: is a very schematic depiction of the arrangement of sealing elements around a nozzle assembly encompassing a row of teeth;

FIG. 10: shows another embodiment of the corresponding assembly for molars;

FIG. 11: shows an embodiment of the enclosed space for incisors;

FIG. 12: shows different sections and views of the assembly according to FIG. 11;

FIG. 13: is a very schematic depiction of a nozzle and a closed volume with the liquid directions;

FIG. 14: shows the assembly according to FIG. 13 with separate inflow;

FIG. 15: shows the assembly according to FIG. 13 with a back-suction opening with a valve flap;

FIG. 16: shows the assembly according to FIG. 15 with a separate inflow;

FIG. 17: shows another embodiment of the nozzle with a closing mechanism;

FIG. 18: shows the embodiment according to FIG. 17 with a separate inflow;

FIG. 19: shows the embodiment according to FIG. 17 with a suction opening;

FIG. 20: is a table of binary codes of the variants of the nozzle assembly;

FIG. 21: shows the suction and ejection through the nozzle relative to a volume-time curve and a pressure-time curve, respectively;

FIG. 22: shows the pressure-time curve for a nozzle with a suction or return opening;

FIG. 23: is a very schematic depiction of the cleaning mechanism;

FIG. 24a-d: show the cleaning mechanisms for shearing particles;

FIG. 25: is a very schematic depiction of a nozzle assembly driven by a volume accumulator and bistable spring;

FIG. 26: shows the relationship between the jet and the rotation as a function of the duration according to D. G. Akhmetov “Vortex Rings” ISBN 978-3-642-05015-2;

FIG. 27: is a visualization of vortex rings as a function of the duration of the jet ejection according to D. G. Akhmetov “Vortex Rings” ISBN 978-3-642-05015-2;

FIG. 28: shows the layout of a torus generator according to D. G. Akhmetov “Vortex Rings” ISBN 978-3-642-05015-2;

FIG. 29: shows an image of a mixed form composed of a jet and torus with particles.

### DETAILED DESCRIPTION OF THE INVENTION

FIG. 1 is a very schematic depiction of the design of a nozzle 1 showing a cross-section through the nozzle 1 in the vicinity of the outlet relative to the outlet direction so that only one half of the nozzle 1 is shown. Below the sloping surface is the liquid space inside the nozzle 1 and above it is the liquid volume, which is placed onto a surface to be cleaned.

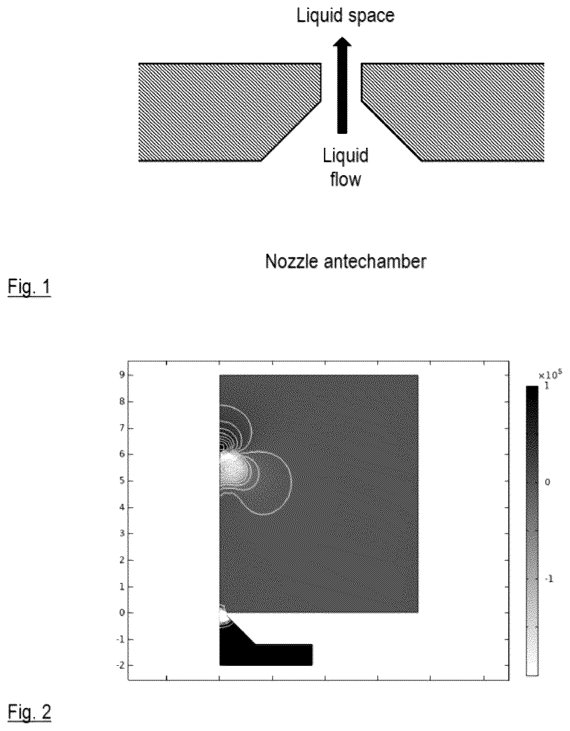

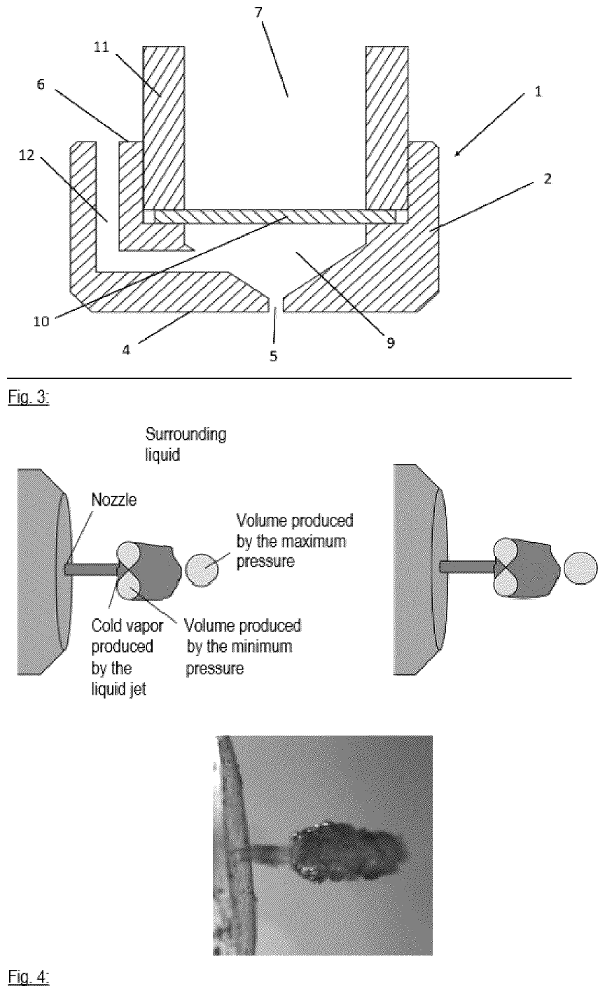

In FIG. 2, the corresponding lines of equal pressure (isobars) are used to show the different pressure conditions prevailing in the liquid when a corresponding pressure surge is ejected through the nozzle 1. It is clear here that an advance region of high pressure is followed by a region of lower pressure, said pressures relating to the ambient pressure.

When such a pressure surge arrives at a surface to be cleaned, the high pressure initially produces a short pulse-like displacement effect caused by the pressure pulse. The pressure difference that is effective here is the one that lies between the ambient pressure and the pressure pulse.

The lagging zone of the negative pressure results in a much more powerful pressure difference at the surface to be cleaned since the pressure here is lower than the ambient pressure.

After the low-pressure region has arrived at the surface to be cleaned, then pressure equalization to the ambient pressure occurs again, which likewise results in corresponding flows again.

This very rapid sequence of comparatively powerful flow changes clearly results in shear forces at the surface, which a biofilm is unable to withstand so that it is opened up at certain points and torn away.

Not only since single pressure pulses are directed at the surface, but also since the pressure pulses are emitted with a frequency of, for example, 50-200 Hz by the at least one nozzle 1, such a high number of pressure differences is produced that the biofilm is unable to withstand it.

The detached biofilm can be flushed away with a cross-bottom flow within the liquid volume, but the latter does not produce its own cleaning effect.

FIG. 3 is a very schematic depiction of the basic design of a nozzle 1; the nozzle 1 depicted therein has a nozzle housing 2.

The nozzle housing 2 has an outlet opening 5 in the vicinity of an outlet-side surface 4.

The nozzle housing 2 is embodied as hollow and cylindrical, with the outlet-side surface 4 terminating the hollow cylinder on the outlet side. An actuation opening 7 is positioned in a surface 6 on the inlet side opposite from this hollow cylinder.

Inside the nozzle 1, a cone-like volume 9 adjoins the outlet opening 5. Opposite from the outlet opening 5, the conical volume 9 is closed off by a circular disc-shaped diaphragm 10. The diaphragm 10 is held in place by a hollow cylindrical actuating connection 11, which is screwed into the nozzle insert 3 preferably from behind, reaching through the inlet-side surface 6 and the actuating opening 7.

In order to provide the conical volume 9 with liquid to be ejected from the outlet opening 5, at least one, but optionally multiple bores 12 are provided, which extend, for example, from a rear side of the nozzle 1 into the conical volume 9. The bores 12 are connected to pressure lines (not shown) that supply the nozzle volume with pressurized liquid in such a way that a movement of the diaphragm 10 that reduces the size of the conical volume 9 results in an ejection of liquid at a predetermined pressure and at a predetermined velocity, but the opposite return movement of the diaphragm preferably does not suck any liquid back through the outlet opening 5.

For this purpose, the bores 12 or the supplying pressure lines can also be provided with valves in such a way that during the pressure surge, the bores 12 are closed to prevent a backflow so that the entire diaphragm movement acting on the conical volume 9 only squeezes the liquid out from the outlet opening 5.

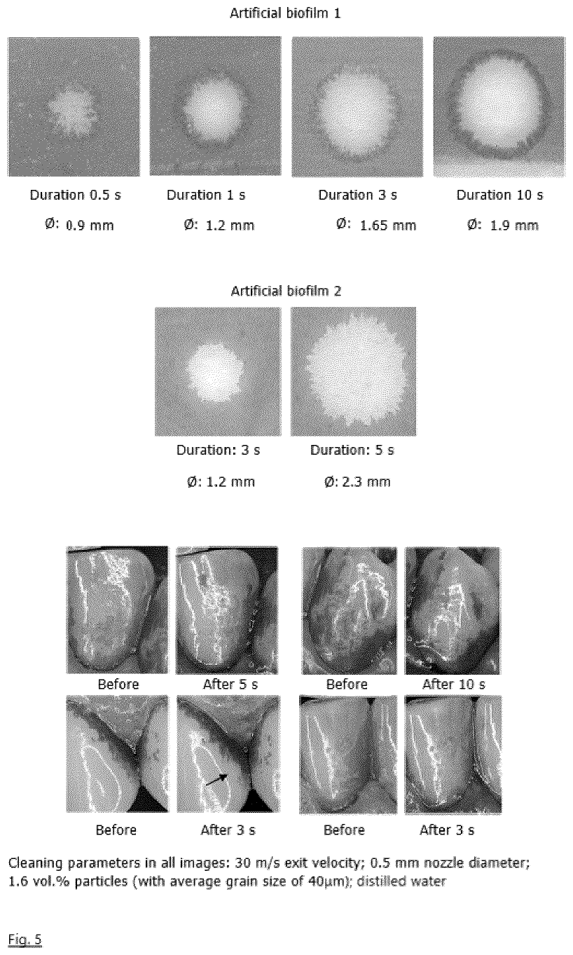

FIG. 4 shows a perspective view of a nozzle 1, from which a pressure surge is being ejected, with a subsequent cold vapor field that is being produced by the negative pressure field in that vapor bubbles are correspondingly being formed by the negative pressure. It is clear that the velocity of the negative pressure field is approximately between 15 and 40 m/s; the cold vapor can travel up to 8 mm before collapsing due to pressure equalization.

This distance is great enough that if cold vapor bubbles form, they can also be conveyed to the surface to be cleaned. The collapsing cold vapor bubbles cause an additional flow effect, so-called microstreaming, which can further improve the cleaning effect. By contrast with bubbles generated by ultrasound, though, the advantage here is that the collapse of the cold vapor bubbles quite clearly does not release so much energy that the surface to be cleaned could be damaged.

In FIG. 5, the cleaning performance of the process according to the invention is shown by means of an example, where the liquids ejected from the nozzles 1 generating the pressure pulse, in this case distilled water, contained 5 g of mineral particles per 100 ml, which corresponds to about 4 volume %. It has turned out that with a particle concentration in the liquid of 10-100 g/l or about 0.4 to 4 volume % and a particle size of 10 to 250 μm, cleaning is promoted without triggering an abrasive effect that would negatively affect the surface of the tooth or gums.

In the comparison, biofilms were used in vivo, which were stained. Here, some interdental regions were painted over and it is clear, particularly in the top center and bottom center as well as top right, that a massive cleaning performance was achieved after 4 and 8 seconds respectively with the test set-up using a nozzle 1.

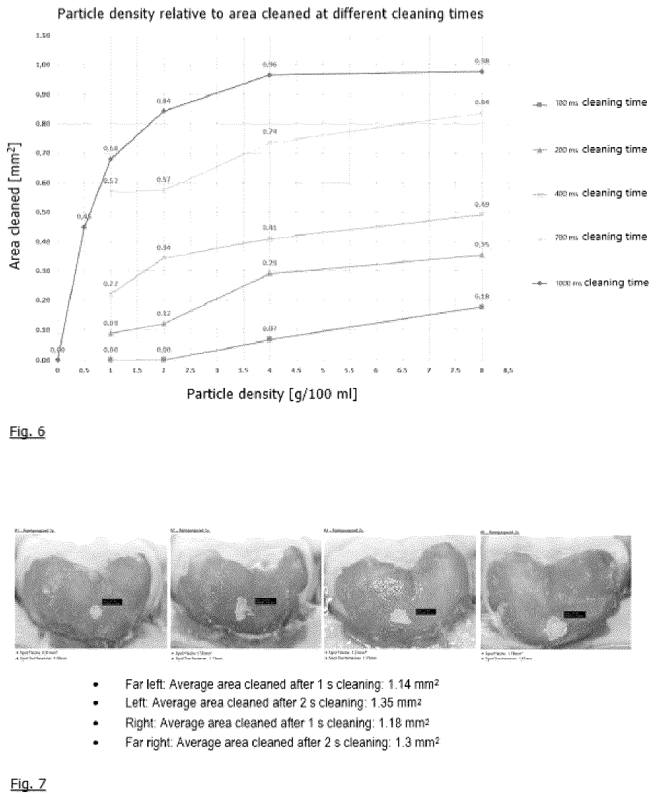

FIG. 6 shows another example of the relationship between the quantity of particles of the size mentioned above and the area cleaned with different cleaning times. It is clear here that with very short cleaning times, the cleaning performance improves significantly with an increasing number of particles, while with increasing cleaning times it is clear that even relatively low particle contents result in an increase in cleaning performance.

With a cleaning time of 1000 milliseconds, the cleaning performance is greatly increased by the particles even at low contents, whereas with a particle density of 4 g per 100 ml of liquid, it is clear that the tooth surface is completely cleaned in the selected time and that doubling the particles does not significantly improve the cleaning performance.

From this it can be concluded that with a longer cleaning time, the particle density in the liquid to be ejected can be significantly reduced.

FIG. 7 shows the results of cleaning tests in which an artificial biofilm was applied to a real tooth and subjected to pressure pulses with a single nozzle assembly. It is clearly visible that there was an increase in cleaning performance after 2 seconds of cleaning.

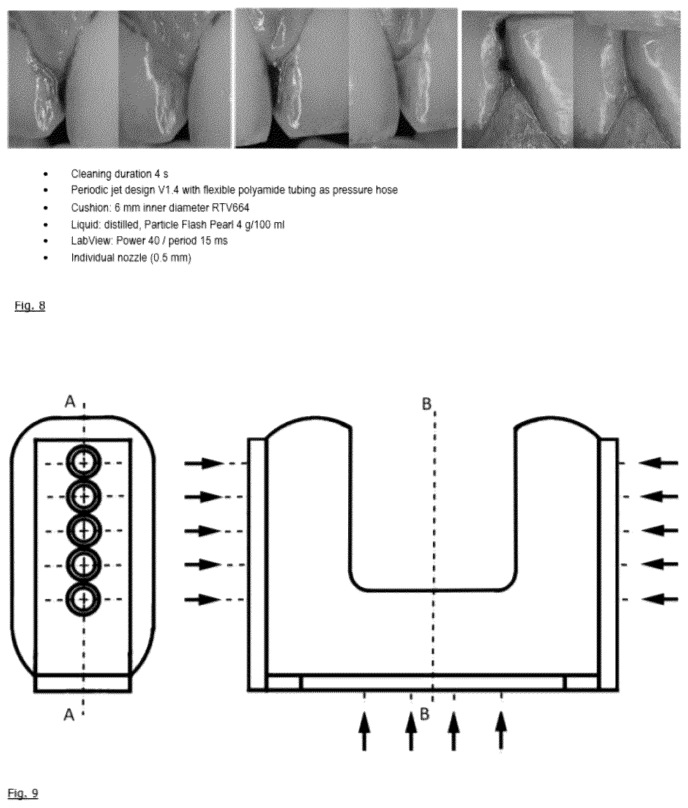

FIG. 8 also shows a biofilm on real teeth; in this case, the interdental region has been acted on. It is clear that even after such short cleaning times, the cleaning performance is also noticeable in the interdental region.

In order to optimize the cleaning performance on the tooth surface and gums and in the interdental regions, particularly in the vicinity of the tooth necks, it is advantageous if multiple nozzles 1 are combined in a nozzle assembly 39.

For example, multiple nozzles 1 can be positioned distributed over the tooth height from the gingival region to the chewing surface. Since biofilm contamination is usually somewhat less pronounced in the vicinity of the chewing surface and the tooth flanks in particular than in the vicinity of the tooth necks and the interdental regions as well as the gingival pockets, the number of them can also be varied over the height so that for example more nozzles per unit area are positioned in the more heavily contaminated regions.

In one advantageous modification, a distance measurement can also be carried out with suitable sensors, irrespective of the number or distribution of the nozzles 1 so that with greater distances between the nozzles and a surface to be cleaned and in particular the interdental regions in the vicinity of the tooth necks, the nozzles 1 are controlled in a different way and in particular, for example, the frequency is increased or the ejection volume of the liquid is increased so that a greater depth effect and range or throw of the jets or pressure pulses is achieved.

Such nozzle assemblies 39 can be arranged, for example, in the form of a so-called shuttle which surrounds one tooth and the adjacent gums and is guided in accordance with a predetermined cleaning duration or continuously at a low speed, for example, from the molars to the incisors or vice versa, thereby sweeping across the teeth, the interdental regions, the interdental regions in the vicinity of the tooth necks, and the adjacent gums.

FIG. 9 is a very schematic depiction of an embodiment that operates with a closed volume in the region of the surface to be cleaned. For this purpose, sealing elements 25 in the form of sealing lips 28 are positioned on a nozzle assembly 39, i.e. a sequence of nozzles 1. The sealing lips 28 close off the region around the nozzle assembly 39 so that a liquid cushion is produced in the same way as with an air cushion, but with the difference that liquid is not supposed to escape to the outside.

Accordingly, in this simplified embodiment, a nozzle housing 20 is shown in a highly schematic fashion (in cross-section), which has a nozzle opening 21; the nozzle housing 20 here is embodied in a simplified manner with a rectangular cross-section.

Corresponding sealing elements 25 are provided in the region of outer edges 24 on an outer, outlet-side surface 23 of the nozzle housing 20 facing the surface 22 to be cleaned. The sealing elements 25 can also be embodied as a single circumferential sealing element 25 and are embodied as rubber-elastic so that on the one hand, they adapt to the geometry of a surface 22 to be cleaned and on the other hand, they are able to ensure a certain internal pressure of the liquid 26 in the enclosed space 27

The sealing elements 25 can in particular be embodied as circumferential sealing elements 25 or circumferential sealing lips 28, which extend away from the outlet-side surface 23 of the nozzle housing 20. In this case, the sealing elements 25 or sealing lips 28 can be embodied with a certain inherent rigidity so that the basic shape of the enclosed space 27 is formed and maintained.

The sealing elements 25 or sealing lips 28 can also be embodied as hollow, for example in order to be inflated with the cleaning liquid 26 so that the sealing elements 24 achieve the shape that they are supposed to have during operation only after being inflated, for example with the cleaning liquid 26 or by the cleaning liquid 26 or by other fluids that are supplied separately.

In a simple embodiment, particularly for cleaning in the region of the molars (FIG. 10), the nozzle housing 20 has, for example, five nozzle openings 21 positioned above one another in the (jaw) sides or facing the tooth flanks 29 and four nozzle openings 21 positioned next to one another at the bottom, facing a tooth crown 30 (only schematically depicted) and the corresponding sealing elements 25, which close off the corresponding enclosed space 27.

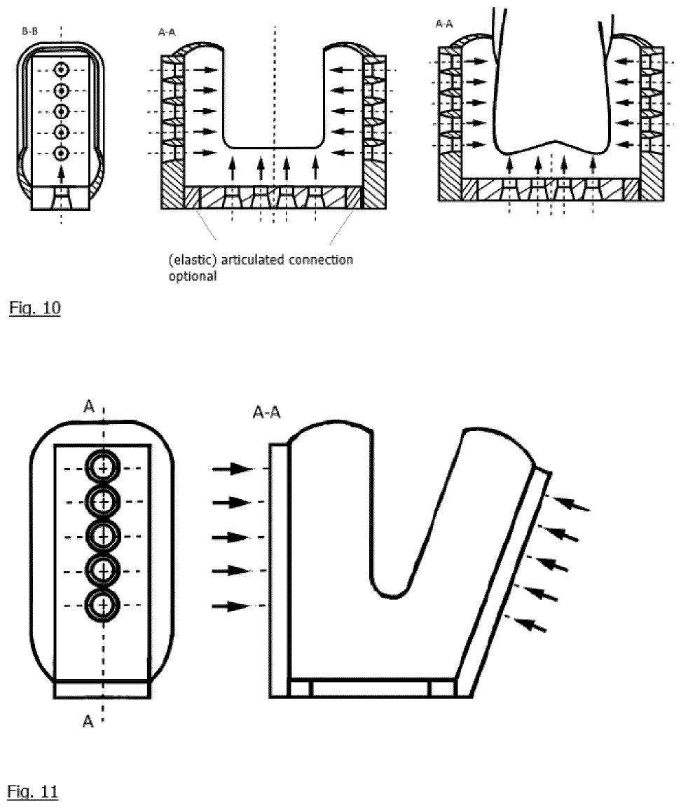

This is shown again in more detail in FIG. 11; in such an embodiment, the lateral nozzle housings 20 are hinged to a nozzle base housing 31 by means of elastic or articulated connections 32, for example rubber-elastic connections 32, particularly so as to allow them to be comfortably adapted to the teeth.

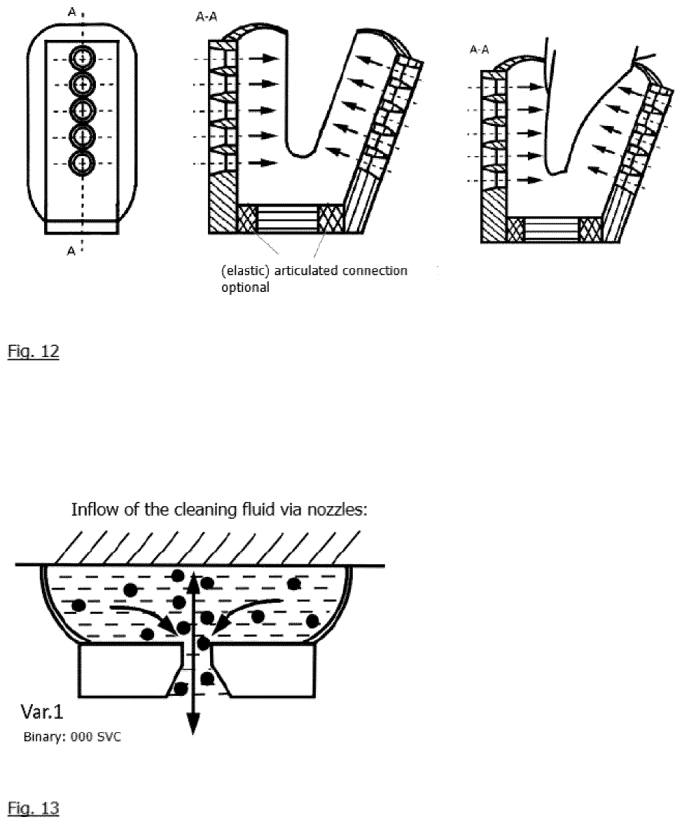

In the incisor region, such an embodiment can optionally differ particularly through the shape of the sealing elements 25, but also optionally through the angle of the nozzle housings 20 and nozzle base housing 31 in order to achieve an adaptation to the incisor region, as is also clear from FIG. 12. In the incisor region, the nozzle base housing 31 can possibly also be embodied without nozzles 1 if the nozzle openings 21 in the nozzle housings 20 that are positioned opposite each other ensure a sufficient flow at an incisor (FIG. 12, right).

In one embodiment, the back-suction according to the invention is provided in order—according to the invention—to not fill the enclosed space 27 with liquid without ejecting this liquid again in a controlled manner. In the simplest case (FIG. 13), the liquid is ejected through the nozzle 1 or nozzle opening 21 into the enclosed space 27 and then is sucked back in through the nozzle opening 21. In order to make it possible to eliminate the requirement for the enclosed space 27 to be filled with one or more nozzles 1 alone before the actual cleaning operation begins, an inlet 36 can be provided in the respective nozzle housing for one or several or all of the nozzles 1, as shown in FIG. 14.

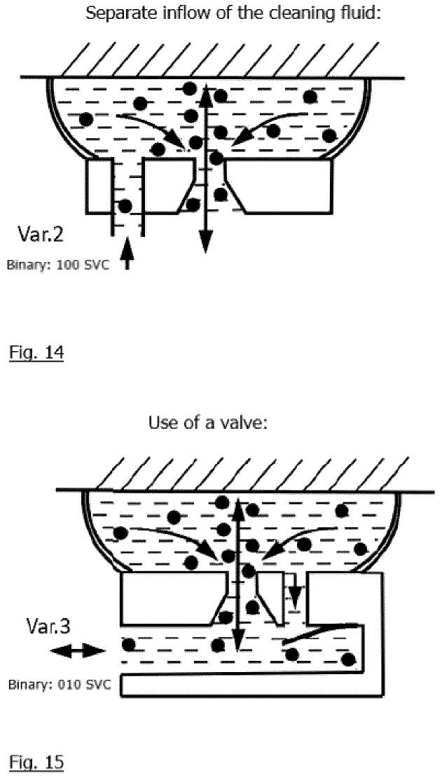

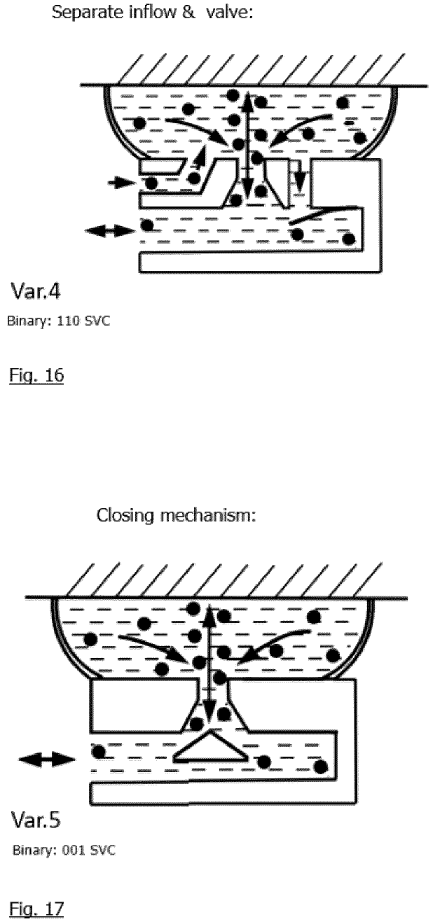

In another embodiment (FIG. 15), in order to increase the backflow performance, the nozzle housing 20 is embodied so that an inflow conduit 33 is provided, into which the nozzle opening 21 opens at its rear end 33, which can thus provide the nozzle opening 21 with cleaning fluid 26; a back-suction opening 34 is provided adjacent to the nozzle opening 21, by means of which liquid 26 can be sucked back into the inflow conduit 33 from the enclosed space 27. A valve 35 is provided that closes the back-suction opening 34 when liquid 26 is flowing in and particularly when liquid 26 is being ejected from the nozzle opening 21 so that the cleaning liquid 26 is ejected only from the nozzle opening 21 in a controlled manner.

If the flow direction in the inflow conduit 33 is subsequently reversed, thereby creating a negative pressure, liquid 26 is drawn back into the inflow conduit 33 from the enclosed space 27 via both the nozzle opening 21 and the back-suction opening 34.

For example, a nozzle housing 20 can be provided with a back-suction opening 34, which is then embodied as possibly larger and possibly slot-shaped (not shown). However, a back-suction opening 34 can also be provided respectively adjacent to one or more nozzle openings or all of the nozzle openings 21.

Each nozzle opening 21 can also be provided with multiple back-suction openings 34 positioned in a ring pattern around the nozzle opening 21, for example.

In another advantageous embodiment, there is also an inflow conduit 33, a back-suction opening 34 with a valve 35, but the inflow conduit 33 is embodied with a separate inflow conduit 36.

In this case as well, one inflow conduit 36 can be provided for an entire nozzle housing with one or more nozzle openings 21 or nozzles 1, one inflow conduit 36 can be provided for one or several or all of the nozzle openings 21, or multiple inflow conduits 36 can be provided for each nozzle opening 21.

In yet another embodiment, a nozzle opening 21 is provided with a closing mechanism 37 capable of closing the nozzle opening 21; the closing mechanism 37 closes this nozzle opening 21, for example from the rear side of the nozzle opening 21, in order, for example, to control certain nozzles 2 separately or to set certain control times between suction and ejection.

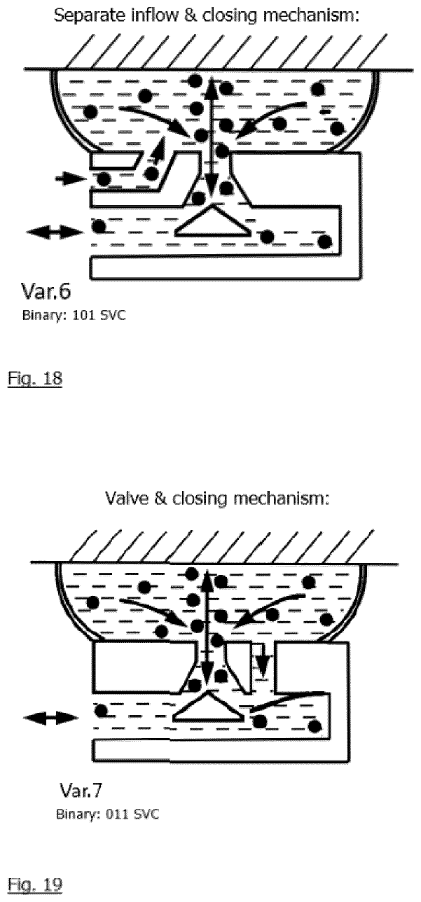

This embodiment according to FIG. 17 can also be embodied with a separate inlet conduit 36 and a separate inlet opening 38 (FIG. 18), furthermore this embodiment can also be embodied with a back-suction opening 34 with a valve 35 according to FIG. 19; the combination with an inlet conduit 36, inlet opening 38, and back-suction opening 34 with a valve 35 is once again possible and accordingly, that which was said before about the number of inflow and outflow openings applies analogously here.

The corresponding permutations that are possible in this connection are shown in the table in FIG. 20. Here S=separate supply, V=valve, and C=closing mechanism. 0 means not present, 1 means present.

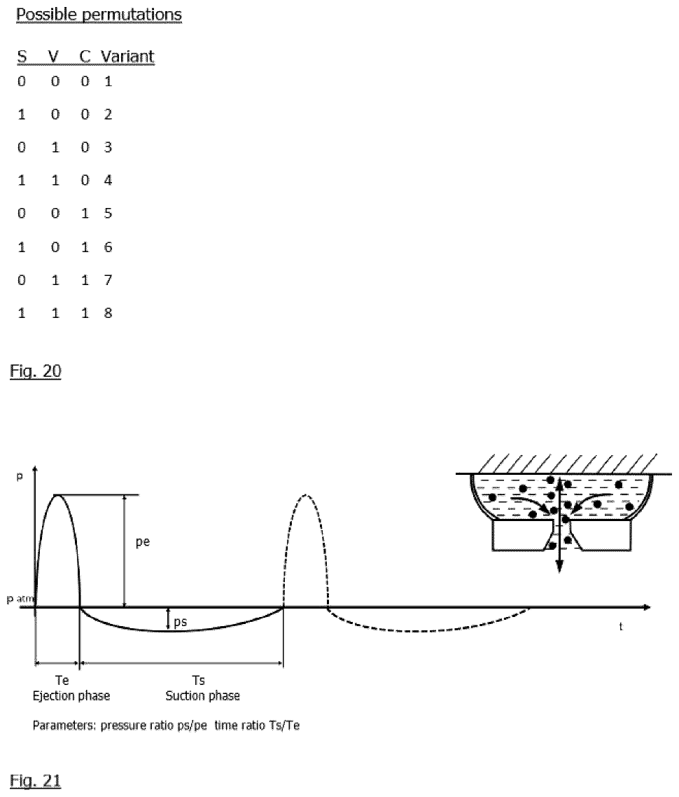

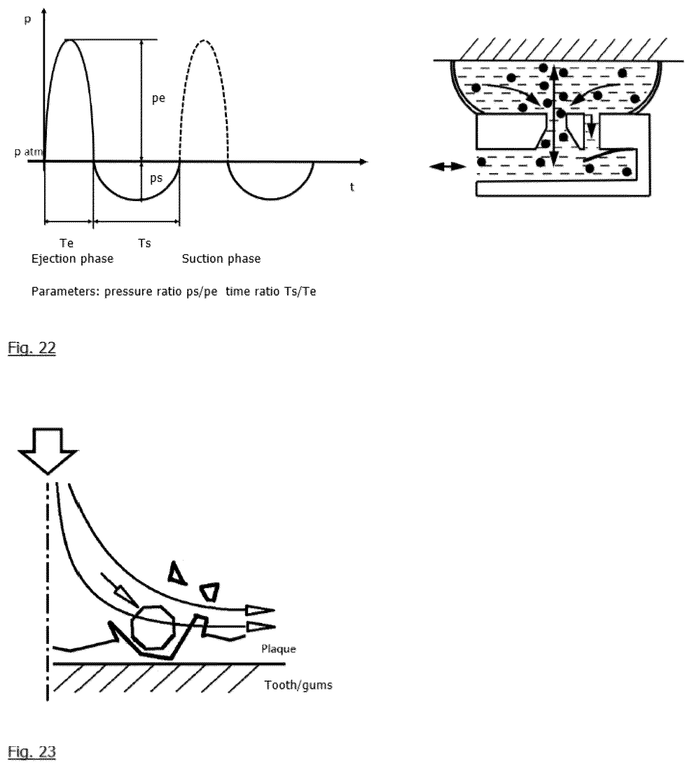

FIG. 21 shows a pressure-time curve that illustrates the ejection from a nozzle and the back-suction over time. The representation here is shown only qualitatively, but it is clear that the ejection phase Te is shorter than the suction phase so that it is not possible to arbitrarily output cleaning pulses at any desired speed.

When using a back-suction opening 34 with a valve 35, the suction phase Ts is significantly shortened compared to the ejection phase so that in this case, a larger sequence of cleaning pulses is possible.

In the case of an assembly with multiple back-suction openings 34, the suction phase Ts is once again significantly shortened so that an even larger sequence of cleaning pulses is possible. This is particularly advantageous since the aim is to perform tooth cleaning in the shortest possible time and yet with a high degree of effectiveness in order to provide the user with added value in terms of time compared to conventional tooth cleaning methods.

In addition, the provision of a back-suction opening has an additional advantage, namely that a flow is produced within the closed space or enclosed space 27, which is focused on average over time and which more easily flushes out any air bubbles possibly contained in the cleaning liquid.

Since particles in particular can be provided, the cleaning performance is also determined by the particles and the particle flow. Since the particles have a higher density than the surrounding fluid, the liquid, when it strikes the surface, does move tangentially away from the surface, but the particles strike the surface and damage the biofilm or plaque, thereby contributing to the removal thereof (FIG. 23).

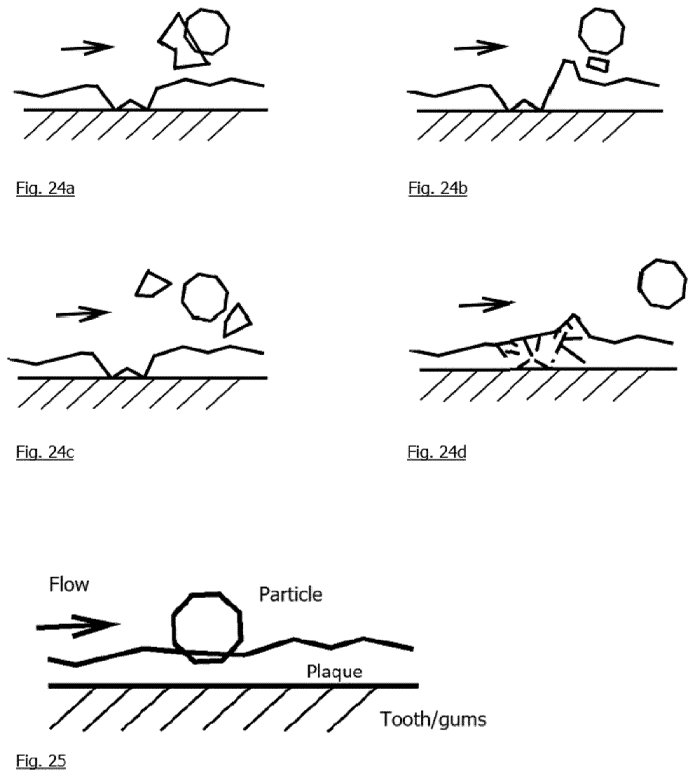

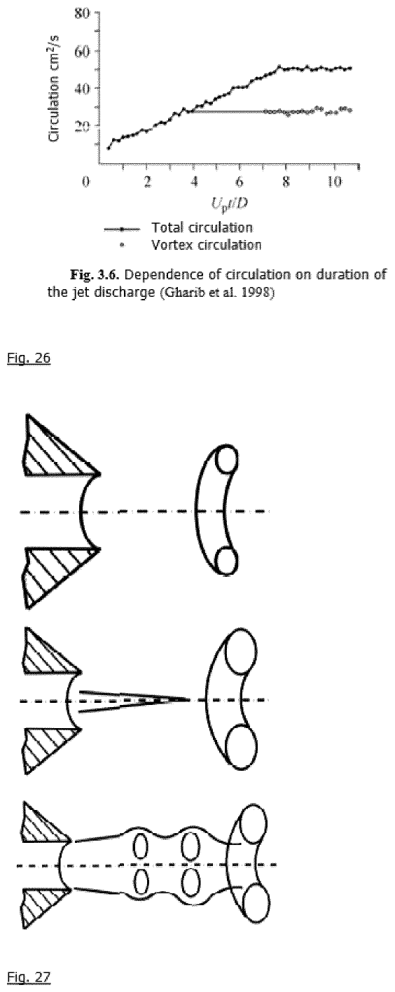

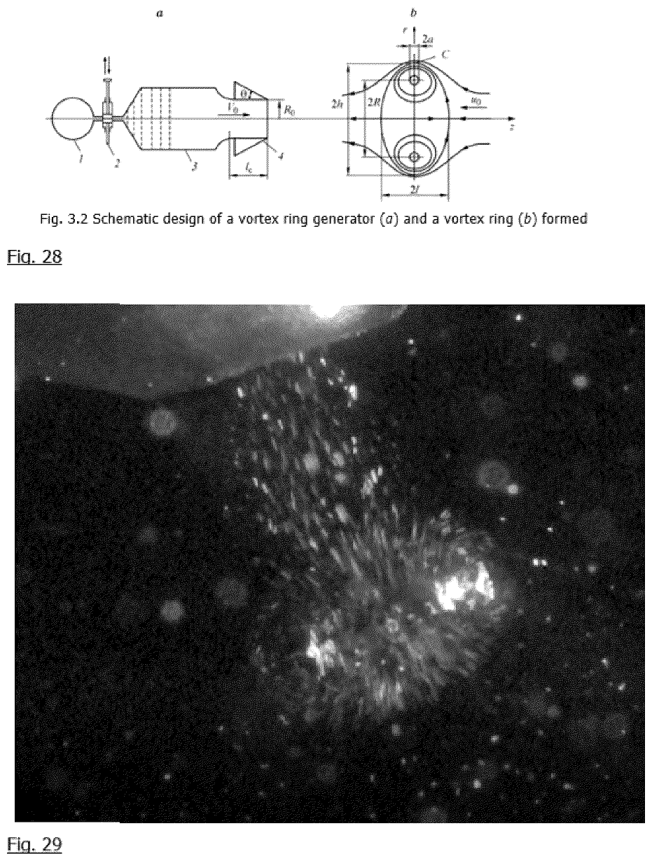

Possible cleaning effects are shown in FIGS. 24a-24d; in this case, it is clear how the particle and plaque come into direct physical contact, with the particle experiencing flow resistance due to the flow parallel to the surface, which moves the particle along and dislodges part of the plaque when the particle adheres to it. In addition, the plaque can also be first deformed and then partially break off (FIG. 24b) or the plaque can break off directly due to local contact forces with the particle, which can also have a cutting effect due to sharp particle edges (FIG. 24c). Mixed cases can also occur in which previous particles have damaged the plaque to such an extent (FIG. 24d) that another particle causes a piece of plaque to detach.

The advantage of the invention is that the method according to the invention provides a gentle but very effective method for cleaning surfaces, in particular teeth and the adjacent gums, which cleans the teeth and gums in an effective, simple, and also quick way, reliably removes biofilms, and is also user-friendly since this method avoids user errors such as excessive brushing pressure and the like.

1. A method for cleaning surfaces of teeth, interdental spaces, and gums, comprising:
comprising directing a pulsed liquid flow onto a surface to be cleaned using at least one nozzle assembly comprising at least one nozzle, wherein at least a portion of the liquid is sucked back in and recirculated.

2. The method according to claim 1, wherein the amount of liquid sucked back in essentially corresponds to the amount of liquid supplied via the at least one nozzle.

3. The method according to claim 1, wherein the surface to be cleaned or a partial region thereof is surrounded by a closed liquid volume in a form of an enclosed space, wherein the at least one nozzle is positioned within the enclosed space.

4. The method according to claim 3, wherein the back-suction takes place inside and/or outside the enclosed space so that the back-suction takes place inside the enclosed space and/or outside the enclosed space in an oral cavity.

5. The method according to claim 3, wherein the amount of liquid sucked back in corresponds to at most +/−20% by volume of the amount of liquid introduced into the enclosed space through the at least one nozzle.

6. The method according to claim 3, wherein a pressure pulse is carried out in such a way that a region of high pressure and a region of lower pressure are generated in the liquid volume, said high and lower pressures relating to an ambient pressure of the liquid in the volume.

7. The method according to claim 6, wherein the pressure pulse is selected to be so strong that the region of the lower pressure produces and entrains cold vapor bubbles.

8. The method according to claim 1, wherein a ratio of the a jet length of the a cylindrical fluid jet to the a jet diameter of up to 10 is set so that toroidal closed vortex filaments are generated.

9. The method according to claim 1, wherein the nozzle assembly includes multiple nozzles.

10. The method according to claim 1, wherein, when the surfaces to be cleaned are not flat or as a function of a distance from the surface, the at least one nozzle is operated so as to control a pulse strength and/or an amount of liquid ejected from the at least one nozzle, wherein when the distance is greater, the pulse strength and/or a pulse duration and/or a pulse frequency and/or a flow rate is/are increased.

11. The method according to claim 1, wherein the at least one nozzle is oscillated around a home position in an X direction (tooth vertical axis) and/or a Y direction (tooth transverse axis) and/or a Z direction (toward the tooth).

12. The method according to claim 1, wherein the at least one nozzle is guided along the teeth.

13. The method according to claim 1, wherein when there are multiple nozzles in the nozzle assembly, the nozzles are arranged so that the nozzles are positioned at least over a height of one tooth and adjacent gums, wherein nozzle jet impingement surfaces of the individual nozzles overlap or, in the case of oscillating nozzle assemblies, overlap.

14. The method according to claim 1, wherein a different nozzle density per unit area of the nozzle assembly is used across a height of a tooth, wherein a higher number of nozzles is used in regions in which the nozzle assembly is spaced farther away from the surface to be cleaned.

15. The method according to claim 1, wherein multiple nozzles are combined in the nozzle assembly, and the nozzle assembly encompasses at least a region of one tooth and adjacent gums in an inverted U-shape.

16. The method according to claim 1, comprising moving the nozzle assembly over the teeth with a moving device.

17. The method according to claim 1, wherein 10 to 100 nozzles are used per nozzle assembly.

18. The method according to claim 1, comprising using a kinetic input pulse energy of up to 16 mJ for large tori and 10 mJ for jets per nozzle.

19. The method according to claim 1, wherein the total pulse energy per mouthpiece for multiple nozzle assemblies and nozzles is 200 to 800 mJ when generating tori, and 200 to 500 mJ when generating jets.

20. The method according to claim 19, wherein the energy per unit time is between 12,000 and 100,000 mJ/s.

21. The method according to claim 1, comprising producing pulsing at a pulse frequency of between 50 and 200 Hz.

22. The method according to claim 1, wherein when producing a jet, a pulsation frequency is between 1 Hz and 1 kHz.

23. The method according to claim 1, wherein when generating a torus, a pulsation frequency is between 1 Hz and 20 kHz, preferably between 1 Hz and 5 kHz, more preferably between 1 Hz and 3 kHz, and particularly between 50 Hz and 1 kHz, and even more preferably from 50 Hz to 300 Hz.

24. The method according to claim 1, wherein when a jet is generated, the pulse lengths are 0.3 ms-1 sec, preferably 0.3 ms-500 ms, more preferably 0.3 to 100 ms, even more preferably 0.3 to 20 ms, and in particular 0.3 ms-5 ms.

25. The method according to claim 1, wherein, when generating a torus, the pulse lengths are can be shorter and in particular, 0.03 ms-3 ms, particularly 0.07 ms to 0.7 ms, preferably 0.1 ms to 0.4 ms.

26. The method according to claim 1, wherein a distance from a surface to be cleaned is set so that it the distance is up to 10 mm when using jets and up to 20 mm when using tori.

339. 0476 6

27. The method according to claim 1, wherein an impact angle of a jet and/or torus on the surface of the tooth is set to range from perpendicular to tangential.

28. The method according to claim 1, wherein an inlet pressure of a jet liquid is set to 0.1 to 2 MPa upstream of the at least one nozzle when producing jets and the inlet pressure of the liquid is set to 0.1 to 4 MPa upstream of the at least one nozzle when producing tori.

29. The method according to claim 3, wherein a particle density in the closed volume is less than 30 percent by volume relative to the liquid contained in the closed volume.

30. The method according to claim 1, wherein a particle density in an initial cleaning liquid that is conveyed in the device is less than 10 percent by volume relative to a volume of the cleaning liquid.

31. The method according to claim 29, wherein mineral particles are used as particles.

32. The method according to claim 29, wherein particles with a particle size of 20-120 μm are used when producing tori with a particle size of up to 0.5 mm.

33. A device for carrying out the method according to claim 1, comprising at least one nozzle or at least one nozzle assembly with multiple nozzles, wherein the at least one nozzle is embodied to eject a jet of cleaning liquid and wherein at least one back-suction device is provided that is embodied to suck back in at least a part of the cleaning liquid ejected by the at least one nozzle.

34. The device according to claim 33, further comprising at least one nozzle housing with at least one sealing element that is embodied to rest against the surface to be cleaned so that a cushion-like enclosed space is formed in front of the at least one nozzle.

35. The device according to claim 34, wherein the at least one sealing element is formed by one or more elastic sealing lips that are positioned around the at least one nozzle or the at least one nozzle housing and are also embodied to rest in an elastically sealing fashion against the surface to be cleaned.

36. The device according to claim 35, wherein the at least one sealing element is positioned on an outer outlet-side surface of a nozzle base body facing the surface to be cleaned, wherein the at least one sealing element is embodied in multiple parts or as a single circumferential sealing element and is embodied as rubber-elastic.

37. The device according to claim 33, wherein multiple nozzles are combined to form the nozzle assembly in a nozzle housing, wherein the nozzles are positioned so that the nozzles extend at least across a height of one tooth and adjacent gums.

38. The device according to claim 33, wherein nozzle jet impingement surfaces of the individual nozzles overlap or, in the case of oscillating nozzle assemblies, overlap.

39. The device according to claim 33, wherein multiple nozzles (1) are combined in the nozzle assembly, and the nozzle assembly encompasses at least a region of one tooth and adjacent gums in an inverted U-shape.

40. The device according to claim 35, wherein the sealing elements or sealing lips are embodied as hollow in order to be inflated with the cleaning liquid or other fluids.

41. The device according to claim 34, wherein the at least one nozzle housing has multiple nozzle openings positioned above one another in (jaw) sides or facing tooth flanks and multiple nozzle openings positioned next to one another at a bottom, facing a tooth crown.

42. The device according to claim 34, lateral nozzle housings are hinged to a nozzle base housing by elastic or articulated connections so as to allow the lateral nozzle housings to be adapted to the teeth.

43. The device according to claim 33, wherein nozzle housings for one or several or all of the nozzles are each provided with an inlet for the cleaning liquid.

44. The device according to claim 34, wherein the at least one nozzle housing is embodied so that an inflow conduit is provided, into which a nozzle opening opens at its a rear end, wherein a back-suction opening is provided adjacent to the nozzle opening, through which the cleaning liquid can be sucked back into the inflow conduit from the enclosed space.

45. The device according to claim 44, further comprising a valve that closes the back-suction opening when the cleaning liquid is flowing in and when the cleaning liquid is being ejected from the nozzle opening so that the cleaning liquid is ejected only from the nozzle opening in a controlled manner.

46. The device according to claim 35, wherein the sealing lips are embodied so that particles cannot get out of the enclosed space but the cleaning liquid can so that an escape of liquid but not of particles takes place to a certain extent so that particles become concentrated in the cleaning fluid volume.
